(19) United States
(12) Patent Application Publication
(10) Pub. No.: US 2022/0154086 A1
(43) Pub. Date: May 19, 2022

(54) METHOD FOR PRODUCING LUBRICANT BASE OIL

(71) Applicant: ENEOS Corporation, Tokyo (JP)

(72) Inventors: Naoya SAITO, Tokyo (JP); Manami NAKAGAWA, Tokyo (JP)

(73) Assignee: ENEOS Corporation, Tokyo (JP)

(21) Appl. No.: 17/442,281

(22) PCT Filed: Mar. 30, 2020
(86) PCT No.: PCT/JP2020/014671

§ 371 Date: Sep. 23, 2021

(30) Foreign Application Priority Data
Mar. 28, 2019 (JP) 2019-064105

(51) Int. Cl. C10G 65/12; C10G 67/02; B01J 21/08; B01J 21/06; B01J 21/04; B01J 27/19; B01J 27/185; C10M 101/02

(52) U.S. Cl. CPC C10G 65/12; C10M 2203/1006; B01J 21/08; B01J 21/066; B01J 21/04; B01J 27/19; B01J 27/1853; C10M 101/025; C10G 2300/202; C10G 2300/308; C10G 2300/4006; C10G 2400/10; C10G 2300/302; C10G 2300/4018; C10G 67/02

(57) ABSTRACT

A method for producing a lubricant base oil includes a first hydrogenation treatment step of bringing a hydrogenation treatment catalyst and a light wax into contact with each other at temperature T₁, and thereby obtaining a first treated oil; a second hydrogenation treatment step of bringing the hydrogenation treatment catalyst and a heavy wax into contact with each other at temperature T₂, and thereby obtaining a second treated oil; and a base oil production step of obtaining a lubricant base oil from a feedstock oil containing at least one selected from the group consisting of the first treated oil and the second treated oil, in which the hydrogenation treatment catalyst is a catalyst obtained by supporting one or more metals selected from the elements of Group 6, Group 8, Group 9, and Group 10 of the Periodic Table of Elements, on an inorganic oxide support.

### TECHNICAL FIELD

The present invention relates to a method for producing a lubricant base oil.

### BACKGROUND ART

Conventionally, various methods for obtaining a lubricant base oil from a wax component have been investigated. For example, Patent Literature 1 discloses a method for producing a lubricant base oil by subjecting a wax-containing raw material to hydrogenation treatment, to catalytic hydrogenation dewaxing, and to hydrogenation refining.

### CITATION LIST

### Patent Literature

[Patent Literature 1] Japanese Unexamined Patent Publication No. 2006-502297

### SUMMARY OF INVENTION

### Technical Problem

There is a plurality of kinds of lubricant base oils according to the purpose of use, and since the low temperature performance and viscosity characteristics that are required from various manufactured products vary, it is desirable to obtain a large quantity of a fraction corresponding to an intended product.

In a case in which a heavier fraction (heavy fraction) than a fraction corresponding to an intended product (product fraction) is used as a raw material, it is preferable that the heavy fraction is converted to lighter fractions by hydrocracking of the raw material. On the other hand, in a case in which a light fraction (light fraction) close to the intended product is used as a raw material, there is a risk that when the raw material is hydrocracked, low-boiling point products are produced, and the yield may be decreased.

Therefore, in conventional production methods, it is necessary to modify the production process to a large extent depending on the type of the raw material.

An object of the present invention is to provide a method for producing a lubricant base oil, by which both light wax and heavy wax can be treated with the same reaction apparatus and the same catalyst, and a lubricant base oil can be efficiently produced from the respective raw materials.

### Solution to Problem

A first aspect of the present invention relates to a method for producing a lubricant base oil, the method including: a first hydrogenation treatment step of causing a light wax having a dynamic viscosity at 100° C. of lower than 6 mm²/s to flow into a first reactor containing a hydrogenation treatment catalyst, bringing the hydrogenation treatment catalyst and the light wax into contact with each other at temperature T₁, and thereby obtaining a first treated oil; a second hydrogenation treatment step of causing a heavy wax having a dynamic viscosity at 100° C. of 6 mm²/s or higher to flow into the first reactor, bringing the hydrogenation treatment catalyst and the heavy wax into contact with each other at temperature T₂, and thereby obtaining a second treated oil; and a base oil production step of obtaining a lubricant base oil from a feedstock oil containing at least one selected from the group consisting of the first treated and the second treated oil. In this production method, the hydrogenation treatment catalyst is a catalyst obtained by supporting one or more metals selected from the elements of Group 6, Group 8, Group 9, and Group 10 of the Periodic Table of Elements, on an inorganic oxide support in which the amount of all acid sites A₁ measured by an ammonia temperature programmed desorption method is 0.5 mmol/g or more, and the temperature T₂ is a temperature higher than the temperature T₁.

In the production method described above, both a light wax and a heavy wax can be treated with the same reactor (first reactor) and the same catalyst. In the production method described above, by adjusting the treatment temperature using a particular catalyst, a light wax can be desulfurized while being suppressed from cracking, and a heavy wax can be desulfurized while being converted to light oil by hydrocracking.

Therefore, a lubricant base oil having suitable low temperature performance and viscosity characteristics can be efficiently produced from both a first treated oil obtainable from a light wax and a second treated oil obtainable from a heavy wax.

According to an embodiment, the inorganic oxide support may be such that the amount of acid sites A₂ measured in a temperature range of 300° C. or higher among the acid sites measured by an ammonia temperature programmed desorption method is 0.2 mmol/g or less.

According to an embodiment, the sulfur content in the light wax may be 10 massppm or more and less than 1,500 massppm, and the sulfur content in the heavy wax may be from 100 massppm to 5,000 massppm.

According to an embodiment, the density at 15° C. of the light wax may be 0.76 g/cm³ or higher and lower than 0.835 g/cm³, and the density at 15° C. of the heavy wax may be from 0.835 g/cm³ to 0.88 g/cm³.

According to an embodiment, the temperature T₁ may be 250° C. or higher and lower than 350° C., and the temperature T₂ may be from 350° C. to 450° C.

According to an embodiment, the base oil production step may include a step of obtaining a dewaxed oil by hydrogenation isomerization dewaxing of the feedstock oil; a step of obtaining a hydrogenation refined oil by hydrogenation refining of the dewaxed oil; and a step of obtaining the lubricant base oil by distillation of the hydrogenation refined oil.

According to an embodiment, the base oil production step may include a step of obtaining a base oil fraction by distillation of the feedstock oil; a step of obtaining a dewaxed oil by hydrogenation isomerization dewaxing of the base oil fraction; a step of obtaining a hydrogenation refined oil by hydrogenation refining of the dewaxed oil; and a step of obtaining the lubricant base oil by distillation of the hydrogenation refined oil.

### Advantageous Effects of Invention

According to the present invention, there is provided a method for producing a lubricant base oil, by which both a light wax and a heavy wax can be treated with the same reaction apparatus and the same catalyst, and a lubricant base oil can be efficiently produced from various raw materials.

### BRIEF DESCRIPTION OF DRAWINGS

FIG. 1 is a flow chart showing an example of a lubricant base oil production apparatus for carrying out a method for producing a lubricant base oil according to an embodiment.

### DESCRIPTION OF EMBODIMENTS

In the following description, suitable embodiments of the present invention will be described with reference to the drawings. Meanwhile, in the description of the drawings, the same symbol will be assigned to the same elements, and any overlapping description will not be repeated herein. Furthermore, in the drawings, some parts are exaggeratedly depicted in order to make the drawing easily understandable, and the dimension ratios and the like are not limited to those described in the drawings.

A method for producing a lubricant base oil according to the present embodiment includes a first hydrogenation treatment step of causing a light wax having a dynamic viscosity at 100° C. of lower than 6 mm²/s to flow into a first reactor containing a hydrogenation treatment catalyst, bringing the hydrogenation treatment catalyst and the light wax into contact with each other at temperature T₁, and thereby obtaining a first treated oil.

Furthermore, the method for producing a lubricant base oil according to the present embodiment further includes a second hydrogenation treatment step of causing a heavy wax having a dynamic viscosity at 100° C. of 6 mm²/s or higher to flow into the first reactor, bringing the hydrogenation treatment catalyst and the heavy wax into contact with each other at temperature T₂, and thereby obtaining a second treated oil. The order of the first hydrogenation treatment step and the second hydrogenation treatment is not particularly limited, the second hydrogenation treatment step may be carried out in the first reactor after the first hydrogenation treatment step has been carried out therein, or the first hydrogenation treatment step may be carried out in the first reactor after the second hydrogenation treatment step has been carried out therein. According to the present embodiment, temperature T₂ is a temperature higher than temperature T₁, and the proportion of sulfur content in the heavy wax is larger than the proportion of the sulfur content in the light wax.

Furthermore, the method for producing a lubricant base oil according to the present embodiment further includes a base oil production step of obtaining a lubricant base oil from a feedstock oil containing at least one selected from the group consisting of the first treated oil and the second treated oil.

According to the present embodiment, the hydrogenation treatment catalyst is a support in which one or more metals selected from the elements of Group 6, Group 8, Group 9, and Group 10 of the Periodic Table of Elements are supported on an inorganic oxide support in which the amount of all acid site A₁ measured by an ammonia temperature programmed desorption method is 0.5 mmol/g or more.

In the method for producing a lubricant base oil according to the present embodiment, both a light wax and a heavy wax can be treated in the same reactor (first reactor). Furthermore, in the production method described above, by using a particular catalyst and adjusting the treatment temperature, a light wax can be desulfurized while being suppressed from cracking, and a heavy wax can be desulfurized while being converted to light wax by hydrocracking. Therefore, a lubricant base oil having suitable low temperature performance and viscosity characteristics can be efficiently produced from both the first treated oil obtainable from a light wax and the second treated oil obtainable from a heavy wax.

Hereinafter, the various steps in the method for producing a lubricant base oil according to the present embodiment will be described in detail.

(First Hydrogenation Treatment Step)

The first hydrogenation treatment step is a step of causing a light wax to flow into a first reactor containing a hydrogenation treatment catalyst, bringing the hydrogenation treatment catalyst and the light wax into contact with each other at temperature T₁, and thereby obtaining a first treated oil.

The hydrogenation treatment catalyst and the light wax may be brought into contact with each other in the presence of hydrogen. That is, the first hydrogenation treatment step may be a step of causing the light wax and hydrogen to flow into the first reactor.

The light wax is a wax having a dynamic viscosity at 100° C. of lower than 6 mm²/s. The dynamic viscosity at 100° C. of the light wax may be 4.5 mm²/s or lower. Furthermore, from the viewpoint that a fraction suitable as a lubricant base oil is easily obtainable, the dynamic viscosity at 100° C. of the light wax is preferably 3 mm²/s or higher, and more preferably 3.5 mm²/s or higher.

The density at 15° C. of the light wax may be, for example, 0.76 g/cm³ or higher, and is preferably 0.77 g/cm³ or higher. Furthermore, the density at 15° C. of the light wax may be, for example, lower than 0.835 g/cm³, and is preferably 0.82 g/cm³ or lower.

The sulfur content in the light wax may be, for example, 10 massppm or more, may be 50 massppm or more, or may be 100 massppm or more. Furthermore, the sulfur content in the light wax may be less than 1,500 massppm, may be 1,000 massppm or less, or may be 500 massppm or less. By using such a light wax, in the first hydrogenation treatment step, a treated oil that has been sufficiently desulfurized is easily obtained while cracking of the light wax is suppressed.

Meanwhile, in the present specification, the sulfur content represents a value measured according to “Crude petroleum and petroleum products-Determination of sulfur content Part 6: Ultraviolet fluorescence method” described in JIS K 2541-6.

The light wax can also be considered as a hydrocarbon oil containing normal paraffin as a main component. The content of normal paraffin in the light wax is, for example, 50 mass % or more, preferably 55 mass % or more, and more preferably 60 mass % or more.

The light wax may include an oil content. The oil content in the light wax may be, for example, 20 mass % or less, or may be 15 mass % or less. In the present specification, the oil content represents a value measured according to “Petroleum waxes” described in JIS K 2235.

The light wax may be, for example, a wax derived from petroleum, may be a wax derived from a synthetic oil synthesized by an FT reaction, or may be a wax obtainable by a solvent dewaxing process.

The hydrogenation treatment catalyst is a catalyst obtained by supporting one or more metals selected from the elements of Group 6, Group 8, Group 9, and Group 10 of the Periodic Table of Elements on an inorganic oxide support.

The amount of all acid sites A₁ measured by an ammonia temperature programmed desorption method with respect to the inorganic oxide support is 0.5 mmol/g or more. As a desulfurization catalyst for treating the light wax, it is general to use a support having fewer acid sites having cracking activity. In contrast, in the present embodiment, an inorganic oxide support in which the amount of all acid sites A₁ is 0.5 mmol/g or more is used, and thereby cracking a heavy wax is enabled in the second hydrogenation treatment step that will be described below.

The upper limit of the amount of all acid sites A₁ is not particularly limited; however, from the viewpoint of further suppressing the cracking of the light wax, the amount of all acid sites A₁ may be, for example, 0.7 mmol/g or less, or may be 0.6 mmol/g or less.

Meanwhile, an ammonia temperature programmed desorption method (ammonia TPD method, Ammonia Temperature Programmed Desorption) is widely known as an effective method for characterizing the acidity of a solid catalyst. For example, it is described in C. V. Hidalgo, et al., Journal of Catalysts, Vol. 85, pp. 362-369 (1984) that the distribution of the amount of acid sites or the acid strength of acid sites can be measured.

An ammonia temperature programmed desorption method is to simultaneously measure the amount of desorbing ammonia and the temperature by adsorbing ammonia, which is a basic probe molecule, onto a solid of a sample and continuously increasing the temperature. Ammonia adsorbed to a weak acid site is desorbed at a low temperature (corresponding to desorption in the range of low heat of adsorption), and ammonia adsorbed to a strong acid site is desorbed at a high temperature (corresponding to desorption in the range of high heat of adsorption). In such an ammonia temperature programmed desorption method, since the acid strength is indicated by temperature of the amount of the heat of adsorption, and a color reaction is not utilized, the solid acid strength and the solid acid amount is measured as a more accurate value.

Meanwhile, according to the present embodiment, the amount of acid sites in the inorganic oxide support represents a value that is determined by an ammonia temperature programmed desorption method of measuring the amount of adsorption of ammonia according to the apparatus and measurement conditions described in “Niwa; Zeolite, 10, 175 (1993)” or the like.

The amount of acid sites A₂ measured in a temperature of 300° C. or higher among the acid sites measured by an ammonia temperature programmed desorption method with respect to the inorganic acid support may be, for example, 0.2 mmol/g or less, and is preferably 0.18 mmol/g or less. Since such a support has a small amount of strong acid sites, cracking of a light wax in the first hydrogenation treatment step is more noticeably suppressed. From the viewpoint that cracking of a heavy wax in the second hydrogenation treatment step that will be described below is further promoted, the amount of acid sites A₂ may be, for example, 0.1 mmol/g or more, and is preferably 0.12 mmol/g or more.

It is preferable that the inorganic oxide support is a porous inorganic oxide. The inorganic oxide support may be, for example, an inorganic oxide including two or more elements selected from the group consisting of alumina, silicon, zirconium, boron, and titanium.

The method for introducing two or more elements selected from the group consisting of aluminum, silicon, zirconium, boron, and titanium into a support is not particularly limited, and examples thereof include a method of preparing a composite oxide using a solution containing a plurality of elements or the like as a raw material; a method of mixing solutions each containing an element and thereby preparing a composite oxide; and a method of adding an acid to a mixture of two or more kinds of inorganic oxides and/or composite oxides, performing kneading into a clay-like form to obtain a kneaded product, and subjecting this kneaded product to extrusion forming, drying, and calcining.

The solution containing an element may be, for example, an aqueous solution of a compound containing an element. Examples of the compound containing an element include, regarding aluminum, aluminum, aluminum hydroxide, boehmite, and the like; regarding silicon, silicon, water glass, silica sol, and the like; regarding zirconium, zirconium sulfate, various alkoxides of zirconium, and the like; regarding boron, boric acid and the like; and regarding titanium, titanium oxysulfide, titanium tetrachloride, various alkoxides of titanium, and the like.

An inorganic oxide including two or more elements is such that since different kinds of inorganic oxides are included, the charge distribution on the surface is localized, acidic protons as surface hydroxyl groups are likely to be produced, and acid sites are likely to be exhibited. It is known that the exhibition of acid sites changes depending on the type of the inorganic oxide, composition, and the like. Therefore, the amount of acid sites, and the ammonia desorption temperature at the time of measuring acid by the ammonia temperature programmed desorption method can be controlled by changing the type of the inorganic oxide, the composition, and the like. From the viewpoint of the exhibition of acid sites, it is preferable that the inorganic oxide support includes another element having a valence different from that of aluminum, which is a trivalent metal.

For example, in a case in which the inorganic oxide support is composed of aluminum and silicon (in a case in which the sum content of aluminum and silicon is 95 mass % or more, and preferably 99 mass % or more, in terms of alumina and silicon dioxide, with respect to the total amount of the inorganic oxide support), the content of aluminum is preferably 30 mass % to 90 mass %, more preferably 40 mass % to 85 mass %, and even more preferably 50 mass % to 80 mass %, in terms of alumina, with respect to the total amount of the inorganic oxide support.

Furthermore, for example, in a case in which the inorganic oxide support is composed of aluminum, silicon, and zirconium (in a case in which the sum content of aluminum, silicon, and zirconium is 95 mass % or more, and preferably 99 mass % or more, in terms of alumina, silicon dioxide, and zirconia, with respect to the total amount of the inorganic oxide support), the content of aluminum is preferably 30 mass % to 90 mass %, more preferably 40 mass % to 80 mass %, and even more preferably 50 mass % to 70 mass %, in terms of alumina, with respect to the total amount of the inorganic oxide support.

Furthermore, for example, in a case in which the inorganic oxide support is composed of aluminum, silicon, and titanium (in a case in which the sum content of aluminum, silicon, and titanium is 95 mass % or more, and preferably 99 mass % or more, in terms of alumina, silicon dioxide, and titania, with respect to the total amount of the inorganic oxide support), the content of aluminum is preferably 30 mass % to 90 mass %, more preferably 40 mass % to 80 mass %, and even more preferably 50 mass % to 70 mass %, in terms of alumina, with respect to the total amount of the inorganic oxide support.

In a case in which an inorganic oxide support including aluminum and an element other than aluminum is prepared, it is preferable that the constituent element other than aluminum is added in a process prior to the calcination of the support. For example, after the raw material is added in advance to an aqueous aluminum solution, an aluminum hydroxide gel including such a constituent component may be prepared, or the above-described raw material may be added to the aluminum hydroxide gel thus prepared. Furthermore, it is also acceptable that the above-described raw material is added in a process of adding water or an acidic aqueous solution to an aluminum oxide intermediate or boehmite powder and kneading the mixture. Furthermore, it is also acceptable that a raw material including a constituent element other than aluminum is prepared in advance, and an alumina raw material such as a boehmite powder may be mixed thereinto. The mechanism for exhibiting the effect brought by a constituent element other than aluminum is not necessarily clearly elucidated; however, it is assumed that the constituent element forms a composite oxide with aluminum, and it is speculated that this causes effects such as an increase in the support surface area and an interaction with active metals, in addition to the effect of exhibiting acid sites, and affects the activity.

The inorganic oxide support may further contain phosphorus as a constituent element. In a case in which the inorganic oxide support contains phosphorus, the content thereof is preferably 0.1 mass % to 10 mass %, more preferably 0.5 mass % to 7 mass %, and even more preferably 2 mass % to 6 mass %, in terms of oxide, with respect to the total amount of the inorganic oxide support. In a case in which the inorganic oxide support contains phosphorus, phosphoric acid or a solution of an alkali metal salt of phosphoric acid or the like can be used.

The hydrogenation treatment catalyst has one or more metals selected from the elements of Group 6, Group 8, Group 9, and Group 10 of the Periodic Table of Elements (hereinafter, also referred to as active metals). It is preferable that the hydrogenation treatment catalyst has, among these, two or more kinds selected from cobalt, molybdenum, nickel, and tungsten. Examples of a suitable combination of the active metals include cobalt-molybdenum, nickel-molybdenum, nickel-cobalt-molybdenum, and nickel-tungsten, and nickel-molybdenum, nickel-cobalt-molybdenum, and nickel-tungsten are more preferred. These active metals may be in any form on the hydrogenation treatment catalyst and can be used in, for example, a sulfide form.

Regarding the hydrogenation treatment catalyst, the sum content of tungsten and molybdenum is preferably 12 mass % or more, and more preferably 15 mass % or more, in terms of oxides, with respect to the total amount of the hydrogenation treatment catalyst. Furthermore, regarding the hydrogenation treatment catalyst, the sum content of tungsten and molybdenum is preferably 35 mass % or less, and more preferably 30 mass % or less, in terms of oxides, with respect to the total amount of the hydrogenation treatment catalyst. When the sum content of tungsten and molybdenum is 12 mass % or more, there may be numerous active sites, and the hydrogenation activity tends to become more satisfactory. Furthermore, when the sum content of tungsten and molybdenum is 35 mass % or less, the dispersibility of the metals is enhanced, and the reaction efficiency tends to be further enhanced.

Regarding the hydrogenation treatment catalyst, the sum content of cobalt and nickel is preferably 1 mass % or more and more preferably 1.5 mass % or more, in terms of oxides, with respect to the total amount of the hydrogenation treatment catalyst. Furthermore, regarding the hydrogenation treatment catalyst, the sum content of cobalt and nickel is preferably 15 mass % or less, and more preferably 13 mass % or less, in terms of oxides, with respect to the total amount of the hydrogenation treatment catalyst. When the sum content of cobalt and nickel is 1 mass % or more, the effect of co-catalyst is markedly exhibited, and the activity tends to be further enhanced. Furthermore, when the sum content of cobalt and nickel is 15 mass % or less, the dispersibility of the metals is enhanced, and the reaction efficiency tends to be further enhanced.

The method of supporting the active metals on the inorganic oxide support is not particularly limited, and any known supporting method can be used without any particular limitations. Regarding the supporting method, for example, a method including a step of impregnating an inorganic oxide support with a solution including an active metal (for example, a solution obtained by dissolving a salt of an active metal) may be mentioned. Furthermore, regarding the supporting method, an equilibrium adsorption method, a Pore-filling method, an Incipient-wetness method, and the like are also preferably employed. For example, a Pore-filling method is a method of measuring the pore volume of a support in advance and impregnating the support with a metal salt solution having the same volume as this pore volume.

The inorganic oxide support may have, as an active component, phosphorus supported thereon together with the active metals. The support amount of phosphorus is preferably 0.5 mass % or more, and more preferably 1 mass % or more, in terms of oxide, with respect to the total amount of the hydrogenation treatment catalyst. Furthermore, the support amount of phosphorus is preferably 10 mass % or less, and more preferably 5 mass % or less, in terms of oxide, with respect to the total amount of the hydrogenation treatment catalyst. The method for supporting phosphorus on a support is not particularly limited, and for example, a method of incorporating phosphorus into the above-mentioned solution including the active metal, and a method of supporting phosphorus before the supporting or after the supporting of the active metal, may be mentioned.

The pore volume of the inorganic oxide support is preferably 0.30 mL/g or more, and more preferably 0.45 mL/g or more. Furthermore, this pore volume is preferably 0.85 mL/g or less, and more preferably 0.80 mL/g or less. When the pore volume is large, the dispersibility of the active metal is enhanced, and the activity tends to be further enhanced. Furthermore, when the pore volume is small, the strength is enhanced, and powdering, crushing, and the like of the catalyst tend to be suppressed.

Furthermore, the average pore diameter of the inorganic oxide support is preferably 5 nm or more, and more preferably 6 nm or more. Furthermore, this average pore diameter is preferably 15 nm or less, and more preferably 12 nm or less. When the average pore diameter is large, the reaction substrate is easily diffused inside the pores, and the reactivity tends to be further enhanced. Furthermore, when the average pore diameter is small, the pore surface area increases, and the activity tends to be further enhanced. The specific surface area, pore volume, and average pore diameter of the inorganic oxide support can be determined by a nitrogen adsorption method. The specific surface area can be determined by a BET method, and the pore volume and the average pore diameter can be determined by a BJH method.

Regarding the inorganic oxide support, from the viewpoint that effective catalyst pores are maintained, and higher activity is exhibited, it is preferable that the proportion occupied by the pore volume originating from pores having a pore diameter of 3 nm or less in the total pore volume is 35 vol % or less.

The first reactor may contain at least one kind of the hydrogenation treatment catalyst mentioned above. The first reactor may contain two or more kinds of the hydrogenation treatment catalyst, and may further contain another catalyst having desulfurization activity.

In the first reactor, the proportion occupied by the above-mentioned hydrogenation treatment catalyst among the catalysts having desulfurization activity is preferably 60 mass % or more, more preferably 70 mass % or more, even more preferably 80 mass % or more, and still more preferably 90 mass % or more.

Furthermore, the first reactor may further contain a guide catalyst, a demetallization catalyst, an inert filler, and the like as necessary, for the purpose of trapping scale components or supporting the hydrogenation treatment catalyst at the border portion of the catalyst bed.

The first hydrogenation treatment step can be said to be a step of causing a light wax to flow into a first reactor containing a hydrogenation treatment catalyst, bringing the hydrogenation treatment catalyst and the light wax into contact with each other under predetermined reaction conditions, and thereby subjecting the light wax to hydrogenation treatment.

In the first hydrogenation treatment step, the hydrogenation treatment catalyst and the light wax are brought into contact with each other at temperature T₁. The temperature T₁ is a temperature lower than temperature T₂ that will be described below. The temperature T₁ may be, for example, 250° C. or higher, and is preferably 280° C. or higher, and more preferably 300° C. or higher. Furthermore, temperature T₁ may be, for example, lower than 350° C., and is preferably 340° C. or lower, and more preferably 330° C. or lower. When the temperature T₁ is in this range, desulfurization of the light wax can be efficiently carried out while cracking of the light wax is suppressed.

In the first hydrogenation treatment step, the reaction conditions other than temperature are not particularly limited and can be appropriately modified according to the desired base oil characteristics and the like. Regarding the reaction conditions, for example, the hydrogen pressure can be set to 2 to 20 MPa, the liquid hourly space velocity (LHSV) can be set to 0.2 to 3 h⁻¹, and the hydrogen-oil ratio (hydrogen/oil ratio) can be set to 500 to 8,000 scfb (89 to 1,425 m³/m³). When the hydrogen pressure and the hydrogen-oil ratio are adjusted to large values, coking can be suppressed, and the reactivity tends to be enhanced. Furthermore, when the hydrogen pressure is too high, it is necessary to make the pressure resistance of the reactor high, and when the hydrogen-oil ratio is too high, a reactor having a large internal volume is needed, while excessively large capital investment may be needed. As the liquid hourly space velocity is lower, it tends to be advantageous to the reaction; however, when the liquid hourly space velocity is too low, an excessively large reactor may be needed. In this application, pressure is expressed in absolute pressure.

The cracking ratio obtainable by the hydrogenation treatment can be determined by the following formula, from the content W₁ of hydrocarbons having a boiling point of 360° C. or higher in the raw material wax (light wax in the first hydrogenation treatment step), and the content W₂ of hydrocarbons having a boiling point of 360° C. or higher in the hydrogenation treatment product.

Cracking ratio (mass %)=100×(W₁−W₂)/W₁

The cracking ratio for the first hydrogenation treatment step is preferably 6.0 mass % or less, and more preferably 3.0 mass % or less. In the first hydrogenation treatment step, for example, the reaction conditions may be appropriately modified such that the cracking ratio reaches the above-described range.

In the first hydrogenation treatment step, a first treated oil is obtained. The sulfur content in the first treated oil may be, for example, 30 massppm or less, and is preferably 20 massppm or less, and more preferably 10 massppm or less. In the first hydrogenation treatment step, for example, the reaction conditions may be appropriately modified such that the sulfur content reaches the above-described range.

In the first hydrogenation treatment step, light fractions such as gas, naphtha, kerosene, and gas oil can be produced by hydrocracking of a light wax; however, the first treated oil may include these light fractions, or may be a product obtained by removing these light fractions from the hydrogenation treatment product.

The density at 15° C. of the first treated oil may be, for example, 0.81 g/cm³ or higher, and is preferably 0.815 g/cm³ or higher. Furthermore, the density at 15° C. of the first treated oil may be, for example, less than 0.835 g/cm³, and is preferably 0.83 g/cm³ or less.

The content of normal paraffin in the first treated oil is, for example, 50 mass % or more, preferably 55 mass % or more, and more preferably 60 mass % or more.

(Second Hydrogenation Treatment Step)

The second hydrogenation treatment step is a step of causing a heavy wax to flow into a first reactor containing a hydrogenation treatment catalyst, bringing the hydrogenation treatment catalyst and the heavy wax into contact with each other at temperature T₂, and thereby obtaining a second treated oil.

The hydrogenation treatment catalyst and the heavy wax may be brought into contact with each other in the presence of hydrogen. That is, the second hydrogenation treatment step may be a step of causing a heavy wax and hydrogen to flow into the first reactor.

The heavy wax is a wax having a dynamic viscosity at 100° C. of 6 mm²/s or higher. The dynamic viscosity at 100° C. of the heavy wax may be 7 mm²/s or higher. Furthermore, from the viewpoint that a fraction suitable as a lubricant base oil is easily obtainable, the dynamic viscosity at 100° C. of the heavy wax is preferably 15 mm²/s or less, and more preferably 12 mm²/s or less.

The density at 15° C. of the heavy wax may be, for example, 0.835 g/cm³ or higher, and is preferably 0.84 g/cm³ or higher. Furthermore, the density at 15° C. of the heavy wax may be, for example, 0.88 g/cm³ or less, and is preferably 0.87 g/cm³ or less.

The sulfur content in the heavy wax may be, for example, 100 massppm or more, may be 500 massppm or more, and may be 1,000 massppm or more. In the present embodiment, since the heavy wax is brought into contact with the hydrogenation treatment catalyst at a temperature higher than the temperature T₁ (temperature T₂), desulfurization can be sufficiently achieved even if the sulfur content is 100 massppm or more. Furthermore, the sulfur content in the heavy wax may be, for example, 5,000 massppm or less, may be 3,000 massppm or less, or may be 2,000 massppm or less. When such a heavy wax is used, the catalyst activity tends to be easily maintained for a long time period. Meanwhile, in the present specification, the sulfur content represents a value measured according to “Crude petroleum and petroleum products-Determination of sulfur content Part 6: Ultraviolet fluorescence method” described in JIS K 2541-6.

The content of normal paraffin in the heavy wax is, for example, 15 mass % or more, preferably 20 mass % or more, and more preferably 25 mass % or more.

The heavy wax may include an oil content. The oil content in the heavy wax may be, for example, 30 mass % or less, or may be 20 mass % or less. In the present specification, the oil content represents a value measured according to “Petroleum waxes” described in JIS K 2235.

The heavy wax may be, for example, a wax derived from petroleum, may be a wax derived from a synthetic oil synthesized by an FT reaction, or may be a wax obtainable by a solvent dewaxing process.

The second hydrogenation treatment step can be said to be a step of causing a heavy wax to flow into a first reactor containing a hydrogenation treatment catalyst, bringing the hydrogenation treatment catalyst and the heavy wax into contact with each other under predetermined reaction conditions, and subjecting the heavy wax to hydrogenation treatment.

In the second hydrogenation treatment step, the hydrogenation treatment catalyst and the heavy wax are brought into contact with each other at temperature T₂. The temperature T₂ is a temperature higher than the above-mentioned temperature T₁. The temperature T₂ may be, for example, 350° C. or higher, and is preferably 370° C. or higher, and more preferably 380° C. or higher. Furthermore, the temperature T₂ may be, for example, 450° C. or lower, and is preferably 430° C. or lower, and more preferably 420° C. or lower. When the temperature T₂ is in this range, hydrocracking of the heavy wax proceeds efficiently, and a treated oil suitable for the production of a lubricant base oil is easily obtained.

In the second hydrogenation treatment step, the reaction conditions other than the temperature are not particularly limited and can be appropriately modified according to the desired base oil characteristics, and the like. Regarding the reaction conditions, for example, the hydrogen pressure can be set to 2 to 20 MPa, the liquid hourly space velocity (LHSV) can be set to 0.2 to 3 h⁻¹, and the hydrogen-oil ratio (hydrogen/oil ratio) can be set to 500 to 8,000 scfb (89 to 1,425 m³/m³). When the hydrogen pressure and the hydrogen-oil ratio are adjusted to large values, coking can be suppressed, and the reactivity tends to be enhanced. Furthermore, when the hydrogen pressure is too high, it is necessary to make the pressure resistance of the reactor high, and when the hydrogen-oil ratio is too high, a reactor having a large internal volume is needed, while excessively large capital investment may be needed. As the liquid hourly space velocity is lower, it tends to be advantageous to the reaction; however, when the liquid hourly space velocity is too low, an excessively large reactor may be needed.

The reaction conditions other than the temperature in the second hydrogenation treatment step may be approximately the same as the reaction conditions other than the temperature in the first hydrogenation treatment step, or may be different therefrom. In a case in which the reaction conditions other than the temperature for the first hydrogenation treatment step and the second hydrogenation treatment step are made to match with each other, the first hydrogenation treatment step and the second hydrogenation treatment step can be switched only by changing the raw material wax (light wax or heavy wax) and the temperature (T₁ or T₂), and more efficient operation is enabled. Meanwhile, when it is said the reaction conditions are approximately the same, this implies a case in which, for example, the difference in the hydrogen pressure is 1 MPa or less, the difference in the liquid hourly space velocity is 0.3 h⁻¹ or less, and the difference in the hydrogen-oil ratio is 500 scfb or less.

The cracking ratio obtainable by hydrogenation treatment can be determined by the following formula, from the content W₁ of hydrocarbons having a boiling point of 360° C. or higher in the raw material wax (heavy wax in the second hydrogenation treatment step), and the content W₂ of hydrocarbons having a boiling point of 360° C. or higher in the hydrogenation treatment product.

Cracking ratio (mass %)=100×(W₁−W₂)/W₁

The cracking ratio for the second hydrogenation treatment step is preferably 15 mass % or higher, and more preferably 20 mass % or higher. Furthermore, the cracking ratio for the second hydrogenation treatment step is preferably 40 mass % or lower, and more preferably 30 mass % or lower. In the second hydrogenation treatment step, for example, the reaction conditions may be appropriately modified such that the cracking ratio reaches the above-described range.

In the second hydrogenation treatment step, a second treated oil is obtained. The sulfur content in the second treated oil may be, for example, 30 massppm or less, and is preferably 20 massppm or less, and more preferably 10 massppm or less. In the second hydrogenation treatment step, for example, the reaction conditions may be appropriately modified such that the sulfur content reaches the above-described range.

In the second hydrogenation treatment step, light fractions such as gas, naphtha, kerosene, and gas oil can be produced by hydrocracking of the heavy wax; however, the second treated oil may include these light fractions or may be a product obtained by removing these light fractions from the hydrogenation treatment product.

The density at 15° C. of the second treated oil may be, for example 0.82 g/cm³ or higher, and is preferably 0.825 g/cm³ or higher. Furthermore, the density at 15° C. of the second treated oil may be, for example, less than 0.865 g/cm³, and is preferably 0.855 g/cm³ or less.

The content of normal paraffin in the second treated oil is, for example, 10 mass % or more, preferably 15 mass % or more, and more preferably 20 mass % or more.

According to the present embodiment, the order of performing the first hydrogenation treatment step and the second hydrogenation treatment step is not particularly limited, and the second hydrogenation treatment step may be carried out after the first hydrogenation treatment step is carried out, or the first hydrogenation treatment step may be carried out after the second hydrogenation treatment step is carried out. Furthermore, in the present embodiment, the first hydrogenation treatment step and the second hydrogenation treatment step may be alternately carried out several times.

In the present embodiment, a lubricant base oil is produced from the first treated oil obtained in the first hydrogenation treatment step and the second treated oil obtained in the second hydrogenation treatment step. According to the present embodiment, the first treated oil and the second treated oil may be supplied respectively individually to the base oil production step that will be described below, or may be supplied as a mixture to the base oil production step that will be described below.

(Base Oil Production Step)

The base oil production step is a step of obtaining a lubricant base oil from a feedstock oil containing at least one selected from the group consisting of the first treated oil and the second treated oil.

In the base oil production step, a lubricant base oil is obtained by treating a feedstock oil according to the form of the production apparatus used, desired characteristics of the lubricant base oil, and the like.

The feedstock oil may further contain a hydrocarbon oil different from the first treated oil and the second treated oil. Furthermore, the feedstock oil may be the first treated oil, the second treated oil, or a mixture of the first treated oil and the second treated oil.

According to an embodiment, the base oil production step may include a step of obtaining dewaxed oil by hydrogenation isomerization dewaxing of a feedstock oil (step A-1), and may further include a step of obtaining hydrogenation refined oil by hydrogenation refining of dewaxed oil (step A-2) and a step of obtaining a lubricant base oil by distillation of hydrogenation refined oil (step A-3). Hereinafter, the various steps according to the present embodiment will be described in detail.

<Step A-1>

Step A-1 is a step of obtaining dewaxed oil by hydrogenation isomerization dewaxing of a feedstock oil. In step A-1, hydrogenation isomerization dewaxing can be carried out by, for example, bringing a feedstock oil into contact with a hydrogenation isomerization catalyst in the presence of hydrogen. As the hydrogenation isomerization catalyst, for example, a catalyst that is generally used for hydrogenation isomerization, that is, a catalyst in which a metal having hydrogenation activity is supported on an inorganic support, or the like can be used.

Regarding the metal having hydrogenation activity in the hydrogenation isomerization catalyst, for example, one or more metals selected from the group consisting of the metals of Group 6, Group 8, Group 9, and Group 10 of the Periodic Table of Elements are used. Specific examples of these metals include noble metals such as platinum, palladium, rhodium, ruthenium, iridium, and osmium; or cobalt, nickel, molybdenum, tungsten, iron, and the like; preferred examples include platinum, palladium, nickel, cobalt, molybdenum, and tungsten; and more preferred examples are platinum and palladium. Furthermore, it is also preferable that a plurality of kinds of these metals is used in combination, and preferred combinations in that case include platinum-palladium, cobalt-molybdenum, nickel-molybdenum, nickel-cobalt-molybdenum, nickel-tungsten, and the like.

Examples of the inorganic support for the hydrogenation isomerization catalyst include metal oxides such as alumina, silica, titania, zirconia, and boria. These metal oxides may be used singly, or may be a mixture of two or more kinds thereof, or a composite metal oxide such as silica-alumina, silica-zirconia, alumina-zirconia, and alumina-boria. From the viewpoint of allowing the hydrogenation isomerization of normal paraffin to proceed efficiently, the above-described inorganic support is preferably a composite metal oxide having solid acidity, such as silica-alumina, silica-zirconia, alumina-zirconia, or alumina-boria. Furthermore, a small amount of zeolite may also be included in the inorganic support. Moreover, for the purpose of enhancing the formability and mechanical strength of the support, the inorganic support may have a binder incorporated therein. Preferred examples of the binder include alumina, silica, magnesia, and the like.

The content of a metal having hydrogenation activity in the hydrogenation isomerization catalyst is, in a case in which this metal is the above-described noble metal, preferably 0.1 to 3 parts by mass with respect to 100 parts by mass of the inorganic support, as metal atoms. Furthermore, the content of the metal having hydrogenation activity in the hydrogenation isomerization catalyst is, in a case in which this metal is a metal other than the above-described noble metal, preferably 2 mass % to 50 mass % in terms of metal oxide. When the content is in such a content range, the metal is satisfactorily dispersible, and high catalytic activity tends to be obtained.

The hydrogenation isomerization catalyst may be a catalyst obtained by supporting one or more metals selected from the elements of Group 6, Group 8, Group 9, and Group 10 of the Periodic Table of Elements on a support formed of a porous inorganic oxide including at least one selected from aluminum, silicon, zirconium, boron, titanium, magnesium, and zeolite.

Examples of the porous inorganic oxide include alumina, titania, zirconia, boria, silica, zeolite, and the like, and among these, an inorganic oxide formed by at least one of titania, zirconia, boria, silica, and zeolite, and of alumina is preferred.

The method for producing a porous inorganic oxide is not particularly limited; however, any arbitrary preparation method can be employed using raw materials in the form of various sols, salt compounds, and the like corresponding to various elements. Furthermore, a porous inorganic oxide may also be prepared by first preparing a composite hydroxide or a composite oxide, such as silica-alumina, silica-zirconia, alumina-titania, silica-titania, or alumina-boria, and then adding the composite hydroxide or composite oxide to any step of the preparation steps in the form of alumina gel or another hydroxide, or in an appropriate solution form. Regarding the ratio between alumina and another oxide, any arbitrary proportion with respect to the support can be adopted. The content of alumina is preferably 90 mass % or less, more preferably 60 mass % or less, and even more preferably 40 mass % or less, and is preferably 10 mass % or more, and more preferably 20 mass % or more, with respect to the total amount of the porous inorganic oxide.

Zeolite is a crystalline aluminosilicate, and examples include faujacite, pentasil, mordenite, TON, MTI,*MRE, *BEA, and the like. A zeolite which has been ultrastabilized by a predetermined hydrothermal treatment and/or an acid treatment, or in which the alumina content in the zeolite has been adjusted, can be used. Preferably, faujacite, mordenite, beta, particularly preferably Y type, and beta type are used. Regarding the Y type, an ultrastabilized one is preferred, and in a zeolite that has been ultrastabilized by a hydrothermal treatment, new pores in the range of greater than 20 Å and 100 Å or less are formed in addition to the intrinsic pore structure called micropores of 20 Å or less. Regarding the hydrothermal treatment conditions, any known conditions can be used.

Regarding the one or more metals selected from the elements of Group 6, Group 8, Group 9, and Group 10 of the Periodic Table of Elements, it is preferable to use one or more metals selected from Pd, Pt, Rh, Ir, and Ni, and it is more preferable to use two or more kinds thereof in combination. Suitable examples of combination include Pd—Pt, Pd—Ir, Pd—Rh, Pd—Ni, Pt—Rh, Pt—Ir, Pt—Ni, Rh—Ir, Rh—Ni, Ir—Ni, Pd—Pt—Rh, Pd—Pt—Ir, Pt—Pd—Ni, and the like. Among these, combinations of Pd—Pt, Pd—Ni, Pt—Ni, Pd—Ir, Pt—Rh, Pt—Ir, Rh—Ir, Pd—Pt—Rh, Pd—Pt—Ni, and Pd—Pt—Ir are more preferred, and combinations of Pd—Pt, Pd—Ni, Pt—Ni, Pd—Ir, Pt—Ir, Pd—Pt—Ni, and Pd—Pt—Ir are even more preferred.

The sum content of one or more metals selected from the elements of Group 6, Group 8, Group 9, and Group 10 of the Periodic Table of Elements is preferably 0.1 mass % to 2 mass %, more preferably 0.2 mass % to 1.5 mass %, and even more preferably 0.25 mass % to 1.3 mass %, as metal atoms, with respect to the total amount of the hydrogenation isomerization catalyst. When the content is in such a content range, metals have satisfactory dispersibility, and high catalytic activity tends to be obtained.

Upon the production of the hydrogenation isomerization catalyst, the method for supporting a metal on a support is not particularly limited, and any known method can be used. Usually, a method of impregnating a support with a solution obtained by dissolving a salt of a metal is preferably employed. Furthermore, an equilibrium adsorption method, a Pore-filling method, an Incipient-wetness method, and the like are also preferably employed.

Regarding the hydrogenation isomerization catalyst, for example, the catalysts described in Japanese Unexamined Patent Publication No. 2017-43688, and the like can be suitably used.

Next, the reaction conditions for step A-1 will be described in detail.

In step A-1, the reaction temperature for hydrogenation isomerization dewaxing is preferably 200° C. to 450° C., and more preferably 280° C. to 400° C. When the reaction temperature is in the above-described range, isomerization of normal paraffin can be allowed to sufficiently proceed while cracking of the feedstock oil is suppressed.

The reaction pressure for hydrogenation isomerization dewaxing is preferably 0.1 to 20 MPa, and more preferably 0.5 to 10 MPa. When the reaction pressure is in the above-described range, deterioration of the catalyst caused by cokes production is suppressed, and the apparatus construction cost can be suppressed.

The liquid hourly space velocity of the feedstock oil with respect to the catalyst during hydrogenation isomerization dewaxing is preferably 0.01 to 100 h⁻¹, and more preferably 0.1 to 50 h⁻¹. When the liquid hourly space velocity is in the above-described range, wax components can be sufficiently reduced or removed while cracking of the feedstock oil is suppressed.

The supply ratio between hydrogen and the feedstock oil (hydrogen-oil ratio) during hydrogenation isomerization dewaxing is preferably 100 to 1,500 Nm³/m³, and more preferably 200 to 800 Nm³/m³. When the hydrogen-oil ratio is in the above-described range, sufficient catalyst performance is easily obtainable, and the apparatus construction cost can be suppressed.

The dewaxed oil obtained in step A-1 is such that the normal paraffin concentration is preferably 10 vol % or less, and more preferably 1 vol % or less.

The dewaxed oil obtained in step A-1 can be suitably used as a raw material for a lubricant base oil. According to the present embodiment, for example, a lubricant base oil can be obtained by going through a step of subjecting the dewaxed oil obtained in step A-1 to hydrogenation refining and thereby obtaining a hydrogenation refined oil (step A-2); and a step of distilling the hydrogenation refined oil and thereby obtaining a lubricant base oil (step A-3).

<Step A-2>

Step A-2 is a step of obtaining hydrogenation refined oil by hydrogenation refining of the dewaxed oil obtained in step A-1. As a result of hydrogenation refining, for example, olefins and aromatic compounds in the dewaxed oil are hydrogenated, and the oxidation stability and color of the lubricant base oil are improved. Furthermore, as sulfur compounds in the dewaxed oil are hydrogenated, a reduction in the sulfur content is also expected.

Hydrogenation refining can be carried out by bringing the dewaxed oil into contact with a hydrogenation refining catalyst in the presence of hydrogen. Regarding the hydrogenation refining catalyst, for example, a catalyst including a support configured to include one or more kinds of inorganic solid acidic substances selected from alumina, silica, zirconia, titania, boria, magnesia, and phosphorus; and one or more active metals selected from the group consisting of platinum, palladium, nickel-molybdenum, nickel-tungsten, and nickel-cobalt-molybdenum, the active metals being supported on the support.

Regarding a suitable support for the hydrogenation refining catalyst, inorganic solid acidic substances including at least two or more kinds of alumina, silica, zirconia, or titania may be mentioned. Regarding the method for supporting active metals on a support, conventional methods such as impregnation and ion exchange can be employed.

The support amount of the active metals in the hydrogenation refining catalyst is preferably 0.1 to 25 parts by mass with respect to 100 parts by mass of the support.

The average pore diameter of the hydrogenation refining catalyst is preferably 6 to 60 nm, and more preferably 7 to 30 nm. When the average pore diameter is in this range, the dispersibility of the active metals is enhanced, and satisfactory catalytic activity tends to be easily obtained.

The pore volume of the hydrogenation refining catalyst is preferably 0.2 mL/g or greater. When the pore volume is 0.2 mL/g or greater, activity deterioration of the catalyst tends to be suppressed. Meanwhile, the pore volume of the hydrogenation refining catalyst may be, for example, 0.5 mL/g or less. Furthermore, the specific surface area of the hydrogenation refining catalyst is preferably 200 m²/g or greater. When the specific surface area of the catalyst is 200 m²/g or greater, the dispersibility of the active metals is enhanced, and the catalytic activity tends to be enhanced. Meanwhile, the specific surface area of the hydrogenation refining catalyst may be, for example, 400 m²/g or less. The specific surface area, the pore volume, and the average pore diameter of the hydrogenation refining catalyst can be determined by a nitrogen adsorption method. The specific surface area can be determined by a BET method, and the pore volume and the average pore diameter can be determined by a BJH method.

Regarding the reaction conditions for hydrogenation refining, for example, a reaction temperature of 200° C. to 300° C., a hydrogen partial pressure of 3 to 20 MPa, a LHSV of 0.5 to 5 h⁻¹, and a hydrogen/oil ratio of 170 to 850 Nm³/m³ are preferred; and a reaction temperature of 200° C. to 300° C., a hydrogen partial pressure of 4 to 18 MPa, a LHSV of 0.5 to 4 h⁻¹, and a hydrogen/oil ratio of 340 to 850 Nm³/m³ are more preferred.

The reaction conditions for hydrogenation refining may be adjusted such that, for example, the sulfur content and the nitrogen content in the hydrogenation refined oil reach 5 massppm or less and 1 massppm or less, respectively. Meanwhile, the sulfur content is a value measured on the basis of “Crude petroleum and petroleum products-Determination of sulfur content Part 6: Ultraviolet fluorescence method” described in JIS K 2541-6, and the nitrogen content is a value measured on the basis of “Crude petroleum and petroleum products-Determination of nitrogen content” of JIS K 2609.

<Step A-3>

Step A-3 is a step of obtaining a lubricant base oil by distillation of the hydrogenation refined oil obtained in step A-2. Step A-3 can be considered as a step of obtaining at least one kind of lubricant base oil by subjecting the hydrogenation refined oil to fractional distillation into a plurality of fractions.

The distillation conditions for step A-3 are not particularly limited as long as the distillation conditions are conditions in which a lubricant base oil can be fractionally distilled from a hydrogenation refined oil. For example, it is preferable that step A-3 is carried out by atmospheric distillation (or distillation under pressure) of distilling off light fractions from the hydrogenation refined oil, and vacuum distillation of fractionally distilling a lubricant base oil from the bottom oil of the atmospheric distillation.

In step A-3, for example, a plurality of lubricant fractions can be obtained by setting a plurality of cut points and subjecting the bottom oil to vacuum distillation. In step A-3, for example, a first lubricant fraction having a 10 vol % distillation temperature of 280° C. or higher and a 90 vol % distillation temperature of 390° C. or lower; a second lubricant fraction having a 10 vol % distillation temperature of 390° C. or higher and a 90 vol % distillation temperature of 490° C. or lower; and a third lubricant fraction having a 10 vol % distillation temperature of 490° C. or higher and a 90 vol % distillation temperature of 530° C. or lower can be respectively fractionally distilled from the hydrogenation refined oil and collected.

The first lubricant fraction can be acquired as a lubricant base oil appropriate for ATF (automatic transmission fluid) or a shock absorber, and in this case, it is preferable that a dynamic viscosity at 100° C. of 2.7 mm²/s is set as a target value. The second lubricant fraction can be acquired as a lubricant base oil appropriate for an engine oil base oil that satisfies the API Group III standards, and in this case, a dynamic viscosity at 100° C. of 4.0 mm²/s is set as a target value. It is preferable to employ a fraction having a dynamic viscosity at 100° C. of from 3.5 mm²/s to 4.5 mm²/s and a pour point of −17.5° C. or lower, as the second lubricant fraction. The third lubricant fraction is an engine oil base oil that satisfies the API Group III standards and can be acquired as, for example, a lubricant base oil appropriate for a diesel engine or the like, and in this case, the dynamic viscosity at 40° C. is aimed to have a value higher than 32 mm²/s, while it is preferable that the dynamic viscosity at 100° C. has a value higher than 6.0 mm²/s. Meanwhile, in the present specification, the dynamic viscosity and viscosity index at 40° C. or 100° C. are values determined on the basis of “Crude petroleum and petroleum products-Determination of kinematic viscosity and calculation of viscosity index from kinematic viscosity” of JIS K 2283.

Meanwhile, the first lubricant fraction can be acquired as a lubricant base oil corresponding to 70 Pale, the second lubricant fraction can be acquired as a lubricant base oil corresponding to SAE-10, and the third lubricant fraction can be acquired as a lubricant base oil corresponding to SAE-20. Meanwhile, the SAE viscosity means the standards defined by the Society of Automotive Engineers.

Furthermore, the API standards are based on the classification of the lubricant grades by the American Petroleum Institute (API), and means Group II (a viscosity index of 80 or higher and lower than 120, a saturated fraction of 90 mass % or more, and a sulfur content of 0.03 mass % or less) and Group III (a viscosity index of 120 or higher, a saturated fraction of 90 mass % or more, and a sulfur content of 0.03 mass % or less). In addition to this, a lubricant base oil having a viscosity index of 130 or higher is referred to as Group III+ and is demanded as a high-quality product that satisfies the API standards or is superior.

Furthermore, the hydrogenation refined oil obtained in step A-2 includes light fractions such as naphtha, kerosene, gas oil, and the like, which are produced as side products by hydrogenation isomerization or hydrocracking. In step A-3, these light fractions may be collected as, for example, fractions having a 90 vol % distillation temperature of 280° C. or lower.

Thus, an embodiment of the base oil production step has been described; however, the base oil production step is not limited to the above-described embodiment. For example, according to another embodiment, the base oil production step may include a step of obtaining a base oil fraction by distillation of a feedstock oil (step B-1) and a step of obtaining a dewaxed oil by hydrogenation isomerization dewaxing of the base oil fraction (step B-2), and may further include a step of obtaining a hydrogenation refined oil by hydrogenation refining of the dewaxed oil (step B-3) and a step of obtaining a lubricant base oil by distillation of the hydrogenation refined oil (step B-4). Hereinafter, the various steps related to this embodiment will be described in detail.

<Step B-1>

In step B-1, a base oil fraction is fractionally distilled from a feedstock oil. Furthermore, in step B-1, light fractions such as gas, naphtha, kerosene, gas oil, and the like may be further fractionally distilled depending on cases. Furthermore, in step B-1, a heavy fraction that is heavier than the base oil fraction may be further fractionally distilled, or this heavy fraction may be collected as bottom oil.

The base oil fraction is a fraction for obtaining a lubricant base oil by being subjected to step B-2 that will be described below (and if necessary, step B-3 and step B-4), and the boiling point thereof may be appropriately changed according to the intended product.

The base oil fraction is preferably a fraction having a 10 vol % distillation temperature of 280° C. or higher and a 90 vol % distillation temperature of 530° C. or lower. When a fraction for which the boiling point range is defined as the above-described range is employed as the base oil fraction, a useful lubricant base oil can be produced more efficiently. Meanwhile, in the present specification, the 10 vol % distillation temperature and the 90 vol % distillation temperature are values measured on the basis of “Petroleum products-Determination of distillation characteristics-Gas chromatography” of JIS K 2254.

The feedstock oil may include, depending on cases, a fraction that is heavy and has a boiling point higher than that of the base oil fraction (heavy fraction), and a fraction that is light and has a boiling point lower than that of the base oil fraction (light fraction), in addition to the base oil fraction. The light fraction is a fraction in which the 90 vol % distillation temperature is lower than the 10 vol % distillation temperature of the base oil fraction, and is a fraction having, for example, a 90 vol % distillation temperature lower than 280° C. The heavy fraction is a fraction in which the 10 vol % distillation temperature is higher than the 90 vol % distillation temperature of the base oil fraction, and is a fraction having, for example, a 10 vol % distillation temperature higher than 530° C.

The distillation conditions for step B-1 are not particularly limited as long as the distillation conditions are conditions in which a base oil fraction can be fractionally distilled from the feedstock oil. For example, step B-1 may be a step of fractionally distilling a base oil fraction from a feedstock oil by vacuum distillation, or may be a step of fractionally distilling a base oil fraction from a feedstock oil by combining atmospheric distillation (or distillation under pressure) and vacuum distillation.

For example, in a case in which the feedstock oil includes a heavy fraction and a light fraction, step B-1 may be carried out by atmospheric distillation (or distillation under pressure) of distilling off a light fraction from a feedstock oil, and vacuum distillation of respectively fractionally distilling a base oil fraction and a heavy fraction from the bottom oil of the atmospheric distillation.

In step B-1, the base oil fraction may be fractionally distilled as a single fraction, or may be fractionally distilled as a plurality of fractions corresponding to a desired lubricant base oil. A plurality of lubricant fractions that have been fractionally distilled as such can be respectively individually supplied to step B-2 of the subsequent stage. Furthermore, some or all of a plurality of base oil fractions can be mixed and supplied to step B-2 of the subsequent stage.

<Step B-2>

Step B-2 is a step of subjecting the base oil fraction obtained in step B-1 to hydrogenation isomerization dewaxing and thereby obtaining dewaxed oil. The hydrogenation isomerization dewaxing in step B-2 can be carried out by, for example, bringing the base oil fraction into contact with a hydrogenation isomerization catalyst in the presence of hydrogen.

Regarding the hydrogenation isomerization catalyst and the reaction conditions for the hydrogenation isomerization dewaxing of step B-2, a hydrogenation isomerization catalyst and reaction conditions similar to those of the above-described step A-1 can be mentioned as an example.

The dewaxed oil obtainable in step B-2 is such that the normal paraffin concentration is preferably 10 vol % or less, and more preferably 1 vol % or less.

The dewaxed oil obtained in step B-2 can be suitably used as a lubricant base oil raw material. According to the present embodiment, for example, a lubricant base oil can be obtained by going through a step of subjecting the dewaxed oil obtained in step B-2 to hydrogenation refining and thereby obtaining hydrogenation refined oil (step B-3), and a step of distilling the hydrogenation refined oil and thereby obtaining a lubricant base oil (step B-4).

<Step B-3>

Step B-3 is a step of subjecting the dewaxed oil obtained in step B-2 to hydrogenation refining and thereby obtaining hydrogenation refined oil. Through hydrogenation refining, for example, olefins and aromatic compounds in the dewaxed oil are hydrogenated, and the oxidation stability and color of the lubricant base oil are improved. Moreover, as sulfur compounds in the dewaxed oil are hydrogenated, a decrease in the sulfur content is also expected.

Step B-3 can be carried out by bringing the dewaxed oil into contact with a hydrogenation refining catalyst in the presence of hydrogen. Regarding the hydrogenation refining catalyst and the reaction conditions for hydrogenation refining in step B-3, hydrogenation refining catalyst and reaction conditions similar to those of the above-described step A-2 can be mentioned as an example.

The reaction conditions for hydrogenation refining may be adjusted such that, for example, the sulfur content and the nitrogen content in the hydrogenation refined oil reach 5 massppm or less and 1 massppm or less, respectively. Meanwhile, the sulfur content is a value measured on the basis of “Crude petroleum and petroleum products-Determination of sulfur content Part 6: Ultraviolet fluorescence method” described in JIS K 2541-6, and the nitrogen content is a value measured on the basis of “Crude petroleum and petroleum products-Determination of nitrogen content” of JIS K 2609.

<Step B-4>

Step B-4 is a step of obtaining a lubricant base oil by distillation of the hydrogenation refined oil obtained in step B-3. Step B-4 can also be considered as a step of fractionally distilling the hydrogenation refined oil into a plurality of fractions and thereby obtaining at least one kind of lubricant base oil.

The distillation conditions for step B-4 are not particularly limited as long as the distillation conditions are conditions in which a lubricant base oil can be fractionally distilled from a hydrogenation refined oil. For example, it is preferable that step B-4 is carried out by atmospheric distillation (or distillation under pressure) of distilling off a light fraction from the hydrogenation refined oil, and vacuum distillation of fractionally distilling a lubricant base oil from the bottom oil of the atmospheric distillation.

In step B-4, for example, a plurality of lubricant fractions can be obtained by setting a plurality of cut points and subjecting the bottom oil to vacuum distillation. In step B-4, for example, a first lubricant fraction having a 10 vol % distillation temperature of 280° C. or higher and a 90 vol % distillation temperature of 390° C. or lower, a second lubricant fraction having a 10 vol % distillation temperature of 390° C. or higher and a 90 vol % distillation temperature of 490° C. or lower, and a third lubricant fraction having a 10 vol % distillation temperature of 490° C. or higher and a 90 vol % distillation temperature of 530° C. or lower can be respectively fractionally distilled and collected from the hydrogenation refined oil.

The first lubricant fraction can be acquired as a lubricant base oil appropriate for ATF or a shock absorber, and in this case, it is preferable to set a dynamic viscosity at 100° C. of 2.7 mm²/s as a target value. The second lubricant fraction can be acquired as a lubricant base oil appropriate for an engine oil base oil that satisfies the API Group III standards, and in this case, a dynamic viscosity at 100° C. of 4.0 mm²/s is set as a target value. It is preferable to employ a fraction having a dynamic viscosity at 100° C. of from 3.5 mm²/s to 4.5 mm²/s and a pour point of −17.5° C. or lower, as the second lubricant fraction. The third lubricant fraction is an engine oil base oil that satisfies the API Group III standards and can be acquired as, for example, a lubricant base oil appropriate for a diesel engine or the like, and in this case, the dynamic viscosity at 40° C. is aimed to have a value higher than 32 mm²/s, while it is preferable that the dynamic viscosity at 100° C. has a value higher than 6.0 mm²/s.

Meanwhile, the first lubricant fraction can be acquired as a lubricant base oil corresponding to 70 Pale, the second lubricant fraction can be acquired as a lubricant base oil corresponding to SAE-10, and the third lubricant fraction can be acquired as a lubricant base oil corresponding to SAE-20. Meanwhile, the SAE viscosity means the standards defined by the Society of Automotive Engineers.

Furthermore, the API standards are based on the classification of the lubricant grades by the American Petroleum Institute (API), and means Group II (a viscosity index of 80 or higher and lower than 120, a saturated fraction of 90 mass % or more, and a sulfur content of 0.03 mass % or less) and Group III (a viscosity index of 120 or higher, a saturated fraction of 90 mass % or more, and a sulfur content of 0.03 mass % or less). In addition to this, a lubricant base oil having a viscosity index of 130 or higher is referred to as Group III+ and is demanded as a high-quality product that satisfies the API standards or is superior.

Furthermore, the hydrogenation refined oil obtained in step B-3 may include light fractions such as naphtha, kerosene, gas oil, and the like, which are produced as side products by hydrogenation isomerization or the like. In step B-4, these light fractions may be collected as, for example, fractions having a 90 vol % distillation temperature of 280° C. or lower.

(Other Steps)

The production method according to the present embodiment may further include another step in addition to the first hydrogenation treatment step, the second hydrogenation treatment step, and the base oil production step described above.

For example, the production method according to the present embodiment may further include steps of obtaining a light wax from a petroleum-based raw material (for example, a solvent extraction step, a hydrogenation step, and a dewaxing step), steps of obtaining a heavy wax from a petroleum-based raw material (for example, a solvent deasphalting step, a solvent extraction step, a hydrogenation step, and a dewaxing step), and the like.

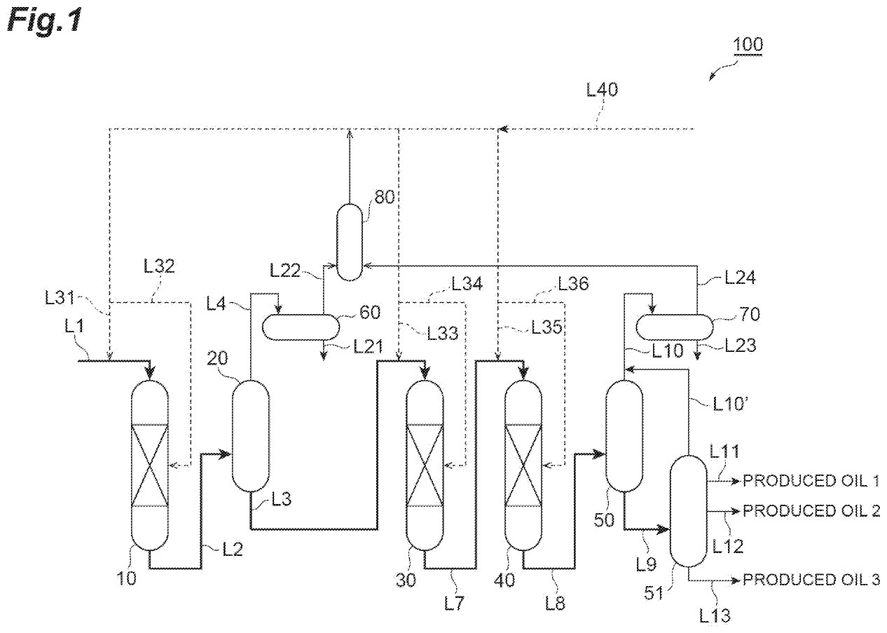

Next, an embodiment of the present invention will be described with reference to the drawings. FIG. 1 is a flow chart showing an example of a lubricant base oil production apparatus for carrying out a method for producing a lubricant base oil according to an embodiment.

The lubricant base oil production apparatus 100 shown in FIG. 1 is configured to include a first reactor 10 in which a light wax or a heavy wax introduced from a flow channel L1 is subjected to hydrogenation treatment; a first separator 20 in which a hydrogenation treatment product supplied from the first reactor through a flow channel L2 is subjected to high-pressure separation (a light fraction is distilled off under pressure); a second reactor 30 in which a bottom oil (first treated oil or second treated oil) supplied from the first separator 20 through a flow channel L3 is subjected to hydrogenation isomerization dewaxing; a third reactor 40 in which a dewaxed oil supplied from the second reactor 30 through a flow channel L7 is subjected to hydrogenation refining; a second separator 50 in which a hydrogenation refined oil supplied from the third reactor 40 through a flow channel L8 is fractionally distilled; and a vacuum distillation column 51 in which a bottom oil supplied from the second separator 50 through a flow channel L9 is subjected to vacuum distillation.

In the first reactor 10, the second reactor 30, and the third reactor 40, hydrogen gas is supplied through a flow channel L40.

In the lubricant base oil production apparatus 100, a flow channel L31 that is branched from the flow channel L40 and is connected to the flow channel L1 is provided, and the hydrogen gas supplied through the flow channel L31 is mixed with a light wax or a heavy wax inside the flow channel L1 and is introduced into the first reactor 10. Furthermore, the first reactor 10 has L32 connected thereto, L32 being branched from the flow channel L40, and the hydrogen pressure and the catalyst layer temperature in the first reactor 10 are adjusted by the supply of hydrogen gas through the flow channel L32.

In the lubricant base oil production apparatus 100, a flow channel L33 that is branched from the flow channel L40 and is connected to the flow channel L3 is also provided, and the hydrogen gas supplied through the flow channel L33 is mixed with the first treated oil or the second treated oil in the flow channel L3 and is introduced into the second reactor 30. Furthermore, the second reactor 30 has a flow channel L34 connected thereto, the flow channel L34 being branched from the flow channel L40, and the hydrogen pressure and the catalyst layer temperature in the second reactor 30 are adjusted by the supply of hydrogen gas through the flow channel L34.

In the lubricant base oil production apparatus 100, a flow channel L35 that is branched from the flow channel L40 and is connected to the flow channel L7 is further provided, and the hydrogen gas supplied through the flow channel L35 is mixed with a dewaxed oil in the flow channel L7 and is introduced into the third reactor 40. Furthermore, the third reactor 40 has a flow channel L36 connected thereto, the flow channel L36 being branched from the flow channel L40, and the hydrogen pressure and the catalyst layer temperature in the third reactor 40 are adjusted by the supply of hydrogen gas through the flow channel L36.

Meanwhile, in the second reactor 30, hydrogen gas that has passed through the second reactor 30 together with the dewaxed oil is taken out by the flow channel L7. Therefore, the amount of hydrogen gas supplied through the flow channel L35 can be appropriately adjusted according to the amount of hydrogen gas taken out from the second reactor 30.

The first separator 20 has a flow channel L4 connected thereto, the flow channel L4 being intended for taking a light fraction and hydrogen gas out of the system. A mixed gas including the light fraction and hydrogen gas taken out through the flow channel L4 is supplied to a first gas-liquid separator 60 and is separated into a light fraction and hydrogen gas. The first gas-liquid separator 60 has a flow channel L21 and a flow channel L22 connected thereto, the flow channel L21 being intended for taking out the light fraction and the flow channel L22 intended for taking out the hydrogen gas.

The second separator 50 has a flow channel L10 connected thereto, the flow channel L10 being intended for taking a light fraction and hydrogen gas out of the system. A mixed gas including the light fraction and hydrogen gas taken out through the flow channel L10 is supplied to a second gas-liquid separator 70 and is separated into a light fraction and hydrogen gas. The second gas-liquid separator 70 has a flow channel L23 and a flow channel L24 connected thereto, the flow channel L23 being intended for taking out the light fraction and the flow channel L24 intended for taking out the hydrogen gas.

The hydrogen gas taken out from the first gas-liquid separator 60 and the second gas-liquid separator 70 is supplied to an acidic gas absorption column 80 through the flow channel L22 and the flow channel L24. The hydrogen gas taken out from the first gas-liquid separator 60 and the second gas-liquid separator 70 includes hydrogen sulfide and the like, which are hydrogenation products of sulfur content, and in the acidic gas absorption column 80, these hydrogen sulfide and the like are removed. The hydrogen gas from which hydrogen sulfide and the like have been removed in the acidic gas absorption column 80 is supplied to the flow channel L40 and is introduced again to the various reactors.

In the vacuum distillation column 51, flow channels L1, L12, and L13 for taking a lubricant fraction that has been fractionally distilled according to the desired lubricant base oil out of the system, are provided.

In the lubricant base oil production apparatus 100, the first hydrogenation treatment step can be carried out by subjecting the light wax supplied through the flow channel L1 to hydrogenation treatment in the first reactor 10. Furthermore, the second hydrogenation treatment step can be carried out by subjecting the heavy wax supplied through the flow channel L1 to hydrogenation treatment in the first reactor 10. In the first reactor 10, the light wax or the heavy wax can be brought into contact with a hydrogenation treatment catalyst in the presence of hydrogen (molecular hydrogen) that has been supplied through the flow channel L31 and the flow channel L32, and be subjected to hydrogenation treatment.

The mode of the first reactor 10 is not particularly limited, and for example, a fixed bed circulation type reactor packed with a hydrogenation treatment catalyst is suitably used. Meanwhile, in the lubricant base oil production apparatus 100, the reactor for hydrogenation treatment is only the first reactor 10; however, in the present embodiment, the lubricant base oil production apparatus may have a plurality of reactors for hydrogenation treatment disposed in series or in parallel. Furthermore, the catalyst bed inside the reactor may be a single bed or a plurality of beds.

In the lubricant base oil production apparatus 100, the reaction product taken out from the first reactor is subjected to high-pressure separation in the first separator 20 and then is supplied to the second reactor.

In the first separator 20, the hydrogenation treatment product supplied through the flow channel L2 is subjected to high-pressure separation (fractional distillation under pressure), and thereby a light fraction can be taken out through the flow channel L4, while a bottom oil (first treated oil or second treated oil) can be taken out through the flow channel L3. Furthermore, in the flow channel L2, the hydrogen gas that has passed through the first reactor 10 together with the hydrogenation treatment product is caused to flow into the first separator 20. In the first separator 20, this hydrogen gas can be taken out together with a light fraction through the flow channel L4.

The lubricant base oil production apparatus 100 may further include a tank and a liquid delivery pump in the middle of the flow channel L3. In this case, for example, when the first treated oil produced in the first hydrogenation treatment step is maintained in this tank, and then the second treated oil produced in the second hydrogenation treatment step is supplied to this tank, the first treated oil and the second treated oil can be supplied in a mixed state, to the second reactor 30. Furthermore, on the contrary, when the second treated oil produced in the second hydrogenation treatment step is maintained in this tank, and then the first treated oil produced in the first hydrogenation treatment step is supplied to this tank, the second treated oil and the first treated oil may be supplied in a mixed state, to the second reactor 30.

In the lubricant base oil production apparatus 100, the base oil production step can be carried out as a process including step A-1, step A-2, and step A-3.

In the lubricant base oil production apparatus 100, step A-1 is carried out in the second reactor 30. In the second reactor 30, a feedstock oil (first treated oil or second treated oil) supplied through the flow channel L3 is brought into contact with a hydrogenation isomerization catalyst in the presence of hydrogen (molecular hydrogen) supplied through the flow channel L33 and the flow channel L34. Thereby, the feedstock oil is dewaxed by hydrogenation isomerization.

The mode of the second reactor 30 is not particularly limited, and for example, a fixed bed circulation type reactor packed with a hydrogenation isomerization catalyst is suitably used. Meanwhile, in the lubricant base oil production apparatus 100, the reactor intended for hydrogenation isomerization dewaxing is only the second reactor 30; however, in the present embodiment, the lubricant base oil production apparatus may have a plurality reactors for hydrogenation isomerization dewaxing disposed in series or in parallel. The catalyst bed inside the reactor may be a single bed or a plurality of beds.

The dewaxed oil obtained via the second reactor 30 is supplied together with the hydrogen gas that has passed through the second reactor 30, to the third reactor 40 through the flow channel L7.

In the lubricant base oil production apparatus 100, step A-2 is carried out in the third reactor 40. In the third reactor 40, the dewaxed oil supplied through the flow channel L7 is brought into contact with a hydrogenation refining catalyst in the presence of the hydrogen (molecular hydrogen) supplied through the flow channel L7, flow channel L35, and flow channel L36, and thereby the dewaxed oil is subjected to hydrogenation refining.

The mode of the third reactor 40 is not particularly limited, and for example, a fixed bed circulation type reactor packed with a hydrogenation refining catalyst is suitably used. Meanwhile, in the lubricant base oil production apparatus 100, the reactor intended for hydrogenation refining is only the third reactor 40; however, in the present embodiment, the lubricant base oil production apparatus may have a plurality of reactors for hydrogenation refining disposed in series or in parallel. Furthermore, the catalyst bed inside the reactor may be a single bed or a plurality of beds.

The hydrogenation refined oil obtained via the third reactor 40 is supplied together with the hydrogen gas that has passed through the third reactor 40, to the second separator 50 through the flow channel L8.

In the lubricant base oil production apparatus 100, step A-3 can be carried out by means of the second separator 50 and the vacuum distillation column 51.

In the second separator 50, the hydrogenation refined oil supplied through the flow channel L8 is subjected to high-pressure separation (fractional distillation under pressure), and thereby fractions lighter than a fraction that is useful as a lubricant base oil (for example, naphtha and fuel oil fractions) can be taken out through the flow channel L10, while a bottom oil can be taken out through the flow channel L9. Furthermore, in the flow channel L8, the hydrogen gas that has passed through the third reactor 40 is caused to flow together with the hydrogenation refined oil; however, in the second separator 50, this hydrogen gas can be taken out through the flow channel L10 together with the light fractions.

In the vacuum distillation column 51, a lubricant fraction can be taken out through the flow channel L11, flow channel L12, and flow channel L13 by subjecting the bottom oil supplied through the flow channel L9 to vacuum distillation, and the lubricant fractions taken out through the various flow channels can be respectively suitably used as lubricant base oils. Furthermore, in the vacuum distillation column 51, a fraction lighter than the lubricant fraction may be extracted through the flow channel L10′ and caused to join into the flow channel L10.

Meanwhile, in the lubricant base oil production apparatus 100, step A-3 is carried out by means of the second separator 50 and the vacuum distillation column 51; however, step A-3 may be carried out by three or more distillation columns. Furthermore, in the vacuum distillation column 51, three fractions are fractionally distilled and then taken out as lubricant fractions; however, in the production method according to the present embodiment, a single fraction may be taken out as the lubricant fraction, or two fractions or four or more fractions can also be fractionally distilled and then taken out as lubricant fractions.

In the lubricant base oil production apparatus 100, a light wax or a heavy wax is subjected to hydrogenation treatment in the first reactor 10. At this time, the sulfur included in the light wax or the heavy wax may be hydrogenated, and thereby hydrogen sulfide may be produced. That is, the hydrogen gas that has passed through the first reactor 10 may include hydrogen sulfide.

When the hydrogen gas that has passed through the first reactor 10 and includes hydrogen sulfide is directly returned to the flow channel L40 and recycled, hydrogen gas including hydrogen sulfide is supplied to the second reactor 30, and the catalytic activity of the second reactor 30 may be deteriorated. Thus, in the lubricant base oil production apparatus 100, the hydrogen gas that has passed through the first reactor 10 passes through the flow channel L2, the first separator 20, the flow channel L4, the first gas-liquid separator 60, and the flow channel L22 and is supplied to the acidic gas absorption column 80, and after hydrogen sulfide is removed therefrom in this acidic gas absorption column 80, the hydrogen gas is returned to the flow channel L40.

Furthermore, in the lubricant base oil production apparatus 100, since the hydrogen gas that has passed through the second reactor 30 and the third reactor 40 may also include hydrogen sulfide produced from the sulfur content slightly included in the base oil fraction, the hydrogen gas is supplied to the acidic gas absorption column 80 through the flow channel L24 and then is returned to the flow channel L40.

In the lubricant base oil production apparatus 100, hydrogen gas is circulated via the acidic gas absorption column 80 as described above; however, in the present embodiment, it is not necessarily essential to circulate hydrogen gas, and hydrogen gas may be supplied independently to each of the various reactors.

Furthermore, the lubricant base oil production apparatus 100 may include a waste water treatment facility for removing ammonia and the like, which are produced by hydrogenation of nitrogen content, in the preceding stage or subsequent stage of the acidic gas absorption column 80. Ammonia is mixed in the stripping steam or the like and is treated in the waste water treatment facility, is converted to NOx together with sulfur by sulfur recovery, and is thereafter converted back to nitrogen by a denitrification reaction.

Thus, an example of the lubricant base oil production apparatus has been described; however, the lubricant base oil production apparatus for carrying out the method for producing a lubricant base oil according to the present embodiment is not intended to be limited to the one described above.

For example, the lubricant base oil production apparatus may further include a vacuum distillation column in which the bottom oil supplied from the first separator 20 through the flow channel L3 is subjected to vacuum distillation, between the first separator 20 and the second reactor 30. In such a lubricant base oil production apparatus, the base oil fraction that has been fractionally distilled in the vacuum distillation column is supplied to the second reactor 30.

According to such a lubricant base oil production apparatus, the base oil production step can be carried out as a process including step B-1, step B-2, step B-3, and step B-4.

Thus, suitable embodiments of the present invention have been described; however, the present invention is not intended to be limited to the above-described embodiments.

### EXAMPLES

Hereinafter, the present invention will be described more specifically by way of Examples; however, the present invention is not intended to be limited to the Examples. Meanwhile, in the following description, a case in which a hydrogenation treatment corresponding to the first hydrogenation treatment step or the second hydrogenation treatment step is carried out is considered as an Example, whereas a case in which a hydrogenation treatment that does not correspond to any of the first hydrogenation treatment step and the second hydrogenation treatment step is carried out is considered as a Comparative Example.

### Production Example 1: Preparation of Hydrogenation Treatment Catalyst (a-1)

Dilute nitric acid was added to a mixture of 40 mass % of silica-zirconia and 60 mass % of alumina, the mixture was kneaded into a clay-like form, and thereby a kneaded product was prepared. This kneaded product was subjected to extrusion forming, drying, and calcination, and thereby a support was prepared. On this support 4 mass % of nickel oxide, 23 mass % of molybdenum oxide, and 3 mass % of phosphorus oxide were supported by an impregnation method, and thereby hydrocracking catalyst (a-1) was obtained.

### Preparation Example 2: Preparation of Hydrogenation Treatment Catalyst (a-2)

Dilute nitric acid was added to a mixture of 70 mass % of silica-zirconia and 30 mass % of alumina, the mixture was kneaded into a clay-like form, and thereby a kneaded product was prepared. This kneaded product was subjected to extrusion forming, drying, and calcination, and thereby a support was prepared. On this support, 11 mass % of nickel oxide and 20 mass % of tungsten oxide were supported by an impregnation method, and thereby hydrocracking catalyst (a-2) was obtained.

### Preparation Example 3: Preparation of Hydrogenation Treatment Catalyst (x-1)

Dilute nitric acid was added to a mixture of 8 mass % of silica-titania and 92 mass % of alumina, the mixture was kneaded into a clay-like form, and thereby a kneaded product was prepared. This kneaded product was subjected to extrusion forming, drying, and calcination, and thereby a support was prepared. On this support, 3 mass % of nickel oxide, 22 mass % of molybdenum oxide, and 3, mass % of phosphorus oxide were supported by an impregnation method, and thereby hydrocracking catalyst (x-1) was obtained.

For the hydrogenation treatment catalysts of Production Examples 1 to 3, the acid sites of the supports were measured by an ammonia temperature programmed desorption method, and the results shown in Table 1 were obtained. Meanwhile, regarding the measuring apparatus, BELCAT manufactured by MicrotracBEL Corp. was used.

TABLE 1

| | | Acid amount (mmol/g) | | |
|---|---|---|---|---|
| | | Preparation Example 1 | Preparation Example 2 | Preparation Example 3 |
| | | Catalyst (a-1) | Catalyst (a-2) | Catalyst (x-1) |
| Measurement | All acid sites | 0.524 | 0.649 | 0.437 |
| temperature | 100° C. to 200° C. | 0.137 | 0.112 | 0.105 |
| | 200° C. to 300° C. | 0.229 | 0.235 | 0.172 |
| | 300° C. to 400° C. | 0.123 | 0.153 | 0.114 |
| | 400° C. to 500° C. | 0.035 | 0.087 | 0.046 |
| | 500° C. to 600° C. | 0.000 | 0.062 | 0.000 |

### Example 1-1

As a light wax, a light wax having the characteristics shown in the following Table 2 was prepared. The light wax was caused to flow into a reactor packed with hydrogenation treatment catalyst (a-1), and hydrogenation treatment was carried out under the conditions shown in the following Table 3. For the hydrogenation treatment product, the cracking ratio and the sulfur content were determined by the methods described below, and the results shown in Table 3 were obtained.

TABLE 2

| | Light wax |
|---|---|
| Density (15° C., g/cm³) | 0.8240 |
| Dynamic viscosity (100° C., mm²/s) | 3.70 |
| Sulfur content (massppm) | 300 |
| Oil content (mass %) | 13.0 |
| Normal paraffin content (mass %) | 61.2 |
| Content W₁ of hydrocarbons having boiling | 98.5 |
| point of 360° C. or higher (mass %) | |

The cracking ratio was determined by the following formula from the content W₁ of hydrocarbons having a boiling point of 360° C. or higher in the raw material wax, and the content W₂ of hydrocarbons having a boiling point of 360° C. or higher in the hydrogenation treatment product.

Cracking ratio (mass %)=100×(W₁−W₂)/W₁

The sulfur content was measured according to “Crude petroleum and petroleum products-Determination of sulfur content Part 6: Ultraviolet fluorescence method” described in JIS K 2541-6.

### Examples 1-2 to 1-4

Hydrogenation treatment was carried out in the same manner as in Example 1-1, except that the conditions for the hydrogenation treatment were changed to the conditions shown in Table 3, and the hydrogenation treatment products were evaluated. The results are shown in Table 3.

TABLE 3

| | Example | Example | Example | Example |
|---|---|---|---|---|
| Reaction | 290 | 310 | 330 | 340 |
| temperature (° C.) | | | | |
| LHSV (h⁻¹) | 1 | 1 | 1 | 1 |
| Hydrogen pressure | 4.9 | 4.9 | 4.9 | 4.9 |
| (MPa) | | | | |
| Hydrogen-oil ratio | 649 | 649 | 641 | 639 |
| (scfb) | | | | |
| Content W₂ of | 96.54 | 96.08 | 96.03 | 95.76 |
| hydrocarbons | | | | |
| boiling point of | | | | |
| 360° C. or (mass %) | | | | |
| Cracking ratio | 1.99 | 2.46 | 2.51 | 2.78 |
| (mass %) | | | | |
| Sulfur content | 86 | 28 | 8 | 3 |
| (massppm) | | | | |

### Example 2-1

As a heavy wax, a heavy wax having the characteristics shown in the following Table 4 was prepared. The heavy wax was caused to flow into a reactor packed with hydrogenation treatment catalyst (a-1), and hydrogenation treatment was carried out under the conditions shown in the following Table 5. For the hydrogenation treatment product, the cracking ratio and the sulfur content were determined, and the results shown in Table 5 were obtained.

TABLE 4

| | Heavy wax |
|---|---|
| Density (15° C., g/cm³) | 0.8540 |
| Dynamic viscosity (100° C., mm²/s) | 7.94 |
| Sulfur content (massppm) | 1576 |
| Oil content (mass %) | 20.1 |
| Normal paraffin content (mass %) | 21.6 |
| Content W₁ of hydrocarbons | 100.0 |
| having boiling point of 3 [symbol] | |
| higher (mass %) | |

[symbol]

indicates data missing or illegible when filed

### Examples 2-2 to 2-8

Hydrogenation treatment was carried out in the same manner as in Example 2-1, except that the conditions for the hydrogenation treatment were changed to the conditions shown in Table 5 or Table 6, and the hydrogenation treatment products were evaluated. The results are shown in Table 5 or Table

TABLE 5

| | Example | Example | Example | Example |
|---|---|---|---|---|
| Reaction | 388 | 394 | 400 | 388 |
| temperature | | | | |
| (° C.) | | | | |
| LHSV (h⁻¹) | 1 | 1 | 1 | 1 |
| Hydrogen | 9.8 | 9.8 | 9.8 | 9.8 |
| pressure (MPa) | | | | |
| Hydrogen-oil | 495 [symbol] | 503 [symbol] | 495 [symbol] | 200 [symbol] |
| ratio (scfb) | | | | |
| Content W₂ of | 84.1 [symbol] | 78.7 [symbol] | 70.6 [symbol] | 80.9 [symbol] |
| hydrocarbons | | | | |
| boiling | | | | |
| point of 360° C. | | | | |
| or higher ( [symbol] | | | | |
| Cracking ratio | 15.8 [symbol] | 21.3 [symbol] | 29.4 [symbol] | 19.0 [symbol] |
| (mass %) | | | | |
| Sulfur content | 5 | 4 | 5 | 11 |
| (massppm) | | | | |

[symbol]

indicates data missing or illegible when filed

TABLE 6

| | Example | Example | Example | Example |
|---|---|---|---|---|
| Reaction | 388 | 390 | 390 | 391 |
| temperature | | | | |
| (° C.) | | | | |
| LHSV (h⁻¹) | 1 | 1 | 1 | 1 |
| Hydrogen pressure | 9.8 | 4.9 | 9.8 | 4.9 |
| (MPa) | | | | |
| Hydrogen-oil | 1489 | 4950 | 650 | 650 |
| ratio (scfb) | | | | |
| Content W₂ of | 81.8 [symbol] | 83.6 [symbol] | 80.5 [symbol] | 79.5 [symbol] |
| hydrocarbons | | | | |
| boiling point of | | | | |
| 360° C. or higher | | | | |
| ( [symbol] | | | | |
| Cracking ratio | 18.1 [symbol] | 16.3 [symbol] | 19.4 [symbol] | 20.4 [symbol] |
| (mass %) | | | | |
| Sulfur content | 2 | 4 | 6 | 5 |
| (massppm) | | | | |

[symbol]

indicates data missing or illegible when filed

### Example 3

As a light wax, a light wax having the characteristics shown in Table 2 was prepared. The light wax was caused to flow into a reactor packed with hydrogenation treatment catalyst (a-2), and hydrogenation treatment was carried out under the conditions shown in the following Table 7. For the hydrogenation treatment product, the cracking ratio and the sulfur content were determined, and the results shown in Table 7 were obtained.

TABLE 7

| | Example 3 |
|---|---|
| Reaction temperature (° C.) | 340 |
| LHSV (h⁻¹) | 1 |
| Hydrogen pressure (MPa) | 4.9 |
| Hydrogen-oil ratio (scfb) | 650 |
| Content W₂ of hydrocarbons having | 93.14 |
| boiling point of 3 [symbol] higher (mass %) | |
| Cracking ratio (mass %) | 5.44 |
| Sulfur content (massppm) | 3 |

[symbol]

indicates data missing or illegible when filed

### Comparative Example 1

As a heavy wax, a heavy wax having the characteristics shown in Table 4 was prepared. The heavy wax was caused to flow into a reactor packed with hydrogenation treatment catalyst (x-1), and hydrogenation treatment was carried out under the conditions shown in the following Table 8. For the hydrogenation treatment product, the cracking ratio and the sulfur content were determined, and the results shown in Table 8 were obtained.

TABLE 8

| | Comparative |
|---|---|
| | Example |
| Reaction temperature (° C.) | 390 |
| LHSV (h⁻¹) | 1 |
| Hydrogen pressure (MPa) | 9.8 |
| Hydrogen-oil ratio (scfb) | 650 |
| Content W₂ of hydrocarbons having | 84.13 |
| boiling point o [symbol] or higher (mass %) | |
| Cracking ratio (mass%) | 15.87 |
| Sulfur content (massppm) | 6 |

[symbol]

indicates data missing or illegible when filed

As described in the Examples, according to the present invention, a light wax could be subjected to desulfurization while cracking is sufficiently suppressed, and a heavy wax could be subjected to conversion into a lighter wax by hydrocracking. From these results, it became clear that a lubricant base oil is produced efficiently from both a light wax and a heavy wax by the production method according to the present invention.

In Comparative Example 1 in which hydrogenation treatment catalyst (x-1) was used, the efficiency for hydrocracking was lowered compared to Example 2-7 under the same conditions.

### REFERENCE SIGNS LIST

10: first reactor, 20: first separator, 30: second reactor, 40: third reactor, 50: second separator, 51: vacuum distillation column, 60: first gas-liquid separator, 70: second gas-liquid separator, 80: acidic gas absorption column, L1, L2, L3, L4, L7, L8, L9, L10, L10′, L11, L12, L13, L21, L22, L23, L24, L31, L32, L33, L34, L35, L36, L40: flow channel, 100: lubricant base oil production apparatus.

1. A method for producing a lubricant base oil, the method comprising:
a first hydrogenation treatment causing a light wax having a dynamic viscosity at 100° C. of lower than 6 mm²/s to flow into a first reactor containing a hydrogenation treatment catalyst, bringing the hydrogenation treatment catalyst and the light wax into contact with each other at temperature T₁, and thereby obtaining a first treated oil;
a second hydrogenation treatment causing a heavy wax having a dynamic viscosity at 100° C. of 6 mm²/s or higher to flow into the first reactor, bringing the hydrogenation treatment catalyst and the heavy wax into contact with each other at temperature T₂, and thereby obtaining a second treated oil; and
a base oil production obtaining a lubricant base oil from a feedstock oil containing at least one selected from the group consisting of the first treated oil and the second treated oil,
wherein the hydrogenation treatment catalyst is a catalyst obtained by supporting one or more metals selected from the elements of Group 6, Group 8, Group 9, and Group 10 of the Periodic Table of Elements, on an inorganic oxide support in which the amount of all acid sites A₁ measured by an ammonia temperature programmed desorption method is 0.5 mmol/g or more, and
the temperature T₂ is a temperature higher than the temperature T₁.

2. The method for producing a lubricant base oil according to claim 1, wherein in the inorganic oxide support, the amount of acid sites A₂ measured in a temperature range of 300° C. or higher among the acid sites measured by an ammonia temperature programmed desorption method is 0.2 mmol/g or less.

3. The method for producing a lubricant base oil according to claim 1, wherein
the sulfur content in the light wax is 10 massppm or more and less than 1,500 massppm, and
the sulfur content in the heavy wax is from 100 massppm to 5,000 massppm.

4. The method for producing a lubricant base oil according to claim 1, wherein
the density at 15° C. of the light wax is 0.76 g/cm³ or higher and lower than 0.835 g/cm³, and
the density at 15° C. of the heavy wax is from 0.835 g/cm³ to 0.88 g/cm³.

5. The method for producing a lubricant base oil according to claim 1, wherein
the temperature T₁ is 250° C. or higher and lower than 350° C., and
the temperature T₂ is from 350° C. to 450° C.

6. The method for producing a lubricant base oil according to claim 1, wherein
the base oil production includes:
obtaining a dewaxed oil by hydrogenation isomerization dewaxing of the feedstock oil;
obtaining a hydrogenation refined oil by hydrogenation refining of the dewaxed oil; and
obtaining the lubricant base oil by distillation of the hydrogenation refined oil.

7. The method for producing a lubricant base oil according to claim 1, wherein
the base oil production includes:
obtaining a base oil fraction by distillation of the feedstock oil;
obtaining a dewaxed oil by hydrogenation isomerization dewaxing of the base oil fraction;
obtaining a hydrogenation refined oil by hydrogenation refining of the dewaxed oil; and
obtaining the lubricant base oil by distillation of the hydrogenation refined oil.
